(19) United States
(12) Patent Application Publication
(10) Pub. No.: US 2021/0278861 A1
(43) Pub. Date: Sep. 9, 2021

(54) MAP GENERATING ROBOT

(71) Applicant: INDOOR ROBOTICS LTD., RAMAT-GAN (IL)

(72) Inventors: DORON BEN-DAVID, RAMAT-GAN (IL); AMIT MORAN, TEL-AVIV (IL)

(21) Appl. No.: 17/049,584

(22) PCT Filed: May 5, 2019
(86) PCT No.: PCT/IL2019/050498

§ 371 Date: Oct. 22, 2020

(30) Foreign Application Priority Data
May 9, 2018 (IL) 259260

(51) Int. Cl. G05D 1/02; G01C 21/20; A47L 9/28; A47L 9/00

(52) U.S. Cl. CPC G05D 1/0274; G05D 1/027; G05D 1/028; G05D 1/0255; G01C 21/206; A47L 9/2852; A47L 2201/04; A47L 9/009; A47L 9/2894; A47L 9/2873; G05D 2201/0203; A47L 2201/02; A47L 9/2805

(57) ABSTRACT

The claimed invention discloses a mobile robot comprising a robot body, a drive system configured to maneuver the robot body in a predefined area, a controller coupled to the drive system, said controller comprising a processor a memory; and a sensor module in communication with the controller, the sensor module comprises at least one non-optical sensor, configured to gather non-optical data from the predefined area. The mobile robot also comprises a communication module configured to send signals to electronic devices in the predefined area, the signals transmitted from the communication module induce emission of signals from the electronic devices in the predefined area. The processor is configured to generate at least one map of the predefined area using data processed from said non-optical data.

### FIELD OF THE INVENTION

The present invention relates to a system and a method for creating a map using a robot, and more particularly to method and system for creating an indoor map by a robot.

### BACKGROUND OF THE INVENTION

Robots are constantly developing and are utilized for many tasks in daily life and our domestic area. For example, self-driving robots have been developed to perform domestic tasks such as vacuum cleaning or washing floors, serving as toys or commencing security duties.

Generally, the domestic robots are configured to move and navigate around. In order to do so, robots today use a variety of sensors to obtain data about their surrounding environment, for example, for navigation, obstacle detection and obstacle avoidance. A spinning LIDAR (light detection and ranging) sensor may be used to detect obstacle while an Ultrasonic sensor may measure the distance to obstacles using sound waves. Other methods such as Stereoscopic vision and Structured light may be used too. Some robots utilize the visual odometry principal, in which the robots calculate optical data received from optical sensors to determine the movement and location of the robot.

However, none of the above provides a profound mapping of an area due to positioning problems of the sensors, obstacles that are not detected by optical sensors due to lack of light or other conditions for the optical sensors. Therefore, a system and a method for creating a profound mapping is required.

### SUMMARY OF THE INVENTION

It is an object of the invention to disclose a mobile robot comprising a robot body, a drive system configured to maneuver the robot body in a predefined area, a controller coupled to the drive system, said controller comprising a processor a memory; and a sensor module in communication with the controller, wherein the sensor module comprises at least one non-optical sensor, configured to gather non-optical data from the predefined area and a communication module configured to send signals to electronic devices in the predefined area, the signals transmitted from the communication module induce emission of signals from the electronic devices in the predefined area, and wherein the processor is configured to generate at least one map of the predefined area using data processed from said non-optical data.

In some cases, the processor creates at least one non-optical map of the predefined area from each one of the said at least one of non-optical data. In some cases, the processor is configured to create a map combining all of the at least one non-optical maps created by the non-optical sensor into a non-optical multilayered map.

In some cases, the non-optical data comprises signal strengths, and wherein the controller is configured to collect signal strengths from the sensor module to detect signal radiating objects.

In some cases, the controller is configured to determine the distance to said signal radiating objects based on the collected signal strength. In some cases, the sensor module further comprises an optical sensor configured to gather optical data from said predefined area. In some cases, the processor creates at least one non-optical map of the predefined area from the optical data. In some cases, the controller is configured to create a map combining all of the at least one non-optical maps created and the optical map into an optical multilayered map. In some cases, the processor creates at least one non-optical map of the predefined area from each one of the said at least one of non-optical data and an optical map from the optical data.

In some cases, the controller is configured to constantly update the at least one generated maps. In some cases, the robot stores the generated maps and the collected data in a memory thereof. In some cases, the controller determines the current location of said robot according to data collected from the sensors relatively to data stored in the memory. In some cases, the at least one non-optical sensor is selected from a group including RF sensor/electromagnetic sensor, ultrasonic sensor, biological sensor/VOC sensor, sound sensor, thermal sensor, gas sensors, electro-mechanical sensors and a combination thereof. In some cases, the at least one non-optical sensor is a discrete sensor.

In some cases, the sensor module further comprises an inertial sensor. In some cases, the inertial sensor may be comprised of at least one of: 3-axis accelerometer, 3-axis gyroscope, magnetometer and barometer. In some cases, the mobile robot further comprising an active navigation module, wherein said active navigation module is configured to communicate with signal emitting objects. In some cases, the active navigation module further comprises a signal emitting beacon, which can be placed in a predefined area.

The subject matter also discloses a system for generating a map of a predetermined area comprising a mobile robot, a docking station and a server. The robot comprises a robot body, a drive system configured to maneuver the robot body in a predefined area, a controller coupled to the drive system, said controller comprising a processor a memory; a sensor module in communication with the controller, wherein the sensor module comprises at least one non-optical sensor, configured to gather non-optical data from the predefined area; and a communication module configured to exchange data with a server or a relay station. The docking station is configured to serve as a relay station for the robot for exchanging data with a remote server, comprising a processor and a communication module; and the server configured to receive and process data; comprising a processor, a communication module and a memory, wherein said remote server is configured to store the collected data, determine the robot's location and transmit the location to the robot and wherein the server generates a map of the predefined area based on the received data.

### BRIEF DESCRIPTION OF THE DRAWINGS

The invention may be more clearly understood upon reading of the following detailed description of non-limiting exemplary embodiments thereof, with reference to the following drawings, in which:

FIG. 1 discloses a schematic block diagram of a mobile robot, according to exemplary embodiments of the subject matter;

FIG. 2 discloses a schematic block diagram of a system utilizing a mobile robot, according to exemplary embodiments of the subject matter;

FIG. 3 discloses a method for mapping a predefined area, according to exemplary embodiments of the subject matter;

FIGS. 4A-4C disclose navigation maneuvers made by the mobile robot during the mapping procedure, according to exemplary embodiments of the subject matter;

FIG. 5 discloses an exemplary predefined area with a mapping robot therein, according to exemplary embodiments of the subject matter;

FIGS. 6A-6B discloses mappings of an exemplary predefined area as generated by a single sensor on a robot, according to exemplary embodiments of the subject matter.

The following detailed description of embodiments of the invention refers to the accompanying drawings referred to above. Dimensions of components and features shown in the figures are chosen for convenience or clarity of presentation and are not necessarily shown to scale. Wherever possible, the same reference numbers will be used throughout the drawings and the following description to refer to the same and like parts.

### DETAILED DESCRIPTION

Illustrative embodiments of the invention are described below. In the interest of clarity, not all features/components of an actual implementation are necessarily described.

The subject matter in the present invention discloses a system and a method for mapping a predefined area by a robot using a plurality of sensors. The term “predefined area” used herein depicts a surface or volume, which the robot is requested, instructed or programmed to map. The surface or volume may be an indoor area such as a house or an outdoor area or a combination thereof. Other predefined areas may be windows, inside surface of pipelines or any other surface robots are capable of moving in, on, underneath or above. In some embodiments, the robot may be a hovering drone (such as quadcopter), a surface bound robot (such as vacuum cleaner robot and window cleaning robot) or any other type of moving electronic robot desired by a person skilled in the art. The term “map” or “mapping” refers to a data structure stored in a computerized or electrical memory, either locally or remotely, which represents the predefined area. The term “localization” used herein depicts both the location of an object in an area and the orientation of that object. The term “Navigate” as used herein comprises, without limitation, determining a route, such as a route from a first location to a second location, and moving in the predefined area in accordance with that route.

Generally, the robot comprises a driving system such as wheels, legs, vacuum pads, continuous track, rotors and fins. In some embodiments the robot may further comprise sensors for collecting information on the environment surrounding the robot. In some embodiments, the robot may further comprise a controller configured to use the data collected by the sensors to determine the location of the robot relatively to the predefined area being mapped or to a general location (e.g. by GPS). Additionally, the driving system may be configured to enable up to 10 Degrees of Freedom (DOF)—(Pitch, Roll, Yaw—Orientation; Ax, Ay, Az—Acceleration (deriving Vx, Vy, Vz and X, Y, Z), Position (X, Y, Z) by magnetometer and height using barometer.

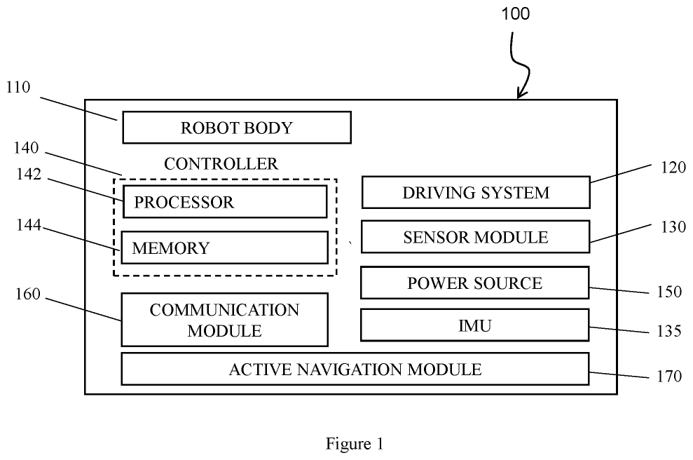

FIG. 1 discloses a schematic block diagram of a mobile robot, according to exemplary embodiments of the subject matter. In some embodiments, a mobile robot 100 having a robot body 110, which comprises a driving system 120, a sensor module 130 and an inertial measurement unit (IMU) 135. In some embodiments, at least one sensor in the sensor module 130 is calibrated with respect to the robot body 110. The driving system 120 and the sensor module 130 are in communication with a controller 140 comprising a processor 142 and a memory 144, coordinating the operation and movement of the mobile robot 100. The robot body 110 may also comprise a power source 150 such as a battery or solar panel. The power source 150 may be electrically coupled with the robot's components. In some embodiments, the mobile robot 100 may further comprise a communication module 160, capable of exchanging data with another device, such as a user's electronic device, a cloud storage, a server and the like.

In some embodiments, the robot body 110 is designed to fit one or more surfaces in a predefined area 105. In some embodiments, if the predefined area 105 is defined as typically planer/horizontal, a hoover drone such as quadcopter or a wheeled body may be in use. If the predefined area 105 is a vertical surface such as a window, a hoover drone or a vacuum-based body would fit. If the predefined area 105 is a pipeline, for example, then a round body might suit better. In some embodiments, the robot body 110 is made from a material which does not radiate or disrupt signals. Such material may be plastic, glass, low composite metal alloys and the like. In some embodiments, the material or composition used to assemble the robot body 110 is designed in a manner to reduce or prevent interference with any of the sensors in the sensor module 130.

In some implementations, the driving system 120 comprises at least one driving elements, designed to allow multi directional movement of the mobile robot 100. The driving system 120 may be adjusted, replaced or changed by a user of the mobile robot in order to allow the mobile robot 100 to move in various planar directions, i.e., side-to-side (lateral), forward/back, and rotational and/or conditions. In some embodiments, the plane might be horizontal or vertical. In further embodiments, the driving system 120 allows the mobile robot 100 to pitch, yaw, or roll.

The robot body 110 is designed to carry the sensor module 130 thereon. The sensor module 130 is situated on the robot body 110 in a manner that enables the sensors of the sensor module 130 to collect data to the satisfaction of the robot user. In some embodiments, the sensor module 130 comprises optical sensors. The optical sensors may include a camera, a hyperspectral optical sensor, an Infrared sensor, an ultraviolet sensor and the like. In further embodiments, the sensor module 130 comprises non-optical sensors. The non-optical sensors comprise at least one of: thermal sensor IR-sensitive sensor, biological sensor for recognizing Volatile Organic Compounds in the air, chemical sensor for recognizing chemical compounds in the air, magnetic sensor for mapping the magnetic field in the area, electromagnetic sensor for measuring the electromagnetic signals (such as RF waves), sonar, acoustic sensor/microphone for measuring noise, moisture sensor, and the like. In some embodiments, the sensors may be used actively to gather data (such as sonar) or passively (such as a camera). In some embodiments, at least one of the sensors of the sensor module 130 may be discrete sensors.

The sensor module 130 and the driving system 120 are in communication with and controlled by the controller 140. Controller 140 is configured to receive data, either optical or non-optical, from the sensor module 130, process the received data and store the processed data in the memory 144 thereof. In some embodiments, the mobile robot 100 is configured to send the received data for processing to remote servers. In such cases, the data is sent by the communication module 160 to the remote server. Additionally, the communication module 160 may receive and store the processed data in the memory 144. The processed data is used for identifying the location of the mobile robot 100 inside the predefined area 105. In some embodiments, the controller 140 is identifying the location of the robot by comparing the data gathered in the current location of the mobile robot 100, with the data stored in the memory 144 thereof.

Furthermore, the controller 140 uses the collected data for generating and updating a map of the predefined area 105. In some embodiments, a separate map is generated in accordance with the data provided by each of the sensors located on the sensor module 130. In other embodiments, the controller 140 generates a single map of the predefined area 105 with pinpoint locations therein based on the processed data received from each sensor.

In some embodiments, the mobile robot 100 may further comprise an active navigation module 170. The active navigation module 170 is configured to utilize transmitters, for example within the communication module 160, and other devices for creating or controlling a signal or a signal source. For example, the mobile robot 100 may comprise a noise generator such as an UltraSound (US) transmitter. In such cases, the mobile robot may activate the US transmitter to transmit an echo across the predefined area. The transmitted echo may be detected by at least one sensor of the sensor module 130, and provide data about the area surrounding the mobile robot according to the detected echo. In such cases, the data received from the echo of the ultrasound may be processed for determining the distance to the walls surrounding the mobile robot 100.

In further embodiments, the mobile robot is configured to place a beacon (not shown) in the predefined area 105. The beacon is a device or object that emits signals, which may be used by the mobile robot to navigate throughout the predefined area 105. In some embodiments, the beacon may be an RF transmitter, transmitting an RF in a known frequency. In other embodiments, the beacon may be a camp fire (started by the mobile robot 100), spreading heat around the fire that can be measured and recorded by the mobile robot. The beacon may be used when there is a large sub-area with no signals.

In further embodiments, the mobile robot is configured to utilize the communication module 160 thereof for activating or associating with objects in the predefined area. In some cases, the mobile robot may send an activation signal or another type of command to a television for turning the television on, altering the television volume, channel, or another property. Upon activation of the TV, the TV starts emitting noise signals and RF signals, which can be sensed by the sensor module 130 of the mobile robot 100. The communication module 160 may send a signal from a predefined list of signals, according to events or rules. The signals sent by the communication module 160 may induce or actuate emission of signals, for example noise signals, electronic signals and the like. The communication module 160 may send a signal requesting status of another device, or a “ping” signal, and the controller 140 receives the status signal from the other device to generate the map. In some embodiments, the mobile robot 100 may receive a list of operable objects and the sub-areas that the objects are located therein. Therefore, the mobile robot 100 may turn on the TV and associate the detected sub-area new signals with a living room.

In some embodiments, several signals of the same type may be received from several signal sources of the same type. For example, three different 2.4 Ghz signals may arrive from a router, a hotspot in a smartphone and from a streamer box. In such cases, a single signal detected by the sensor module 130 may comprise all three signals. In some embodiments, the controller 140 may be configured to break the signal using demodulation methods known to a professional having ordinary skill in the art, and handle the single signal as three signals.

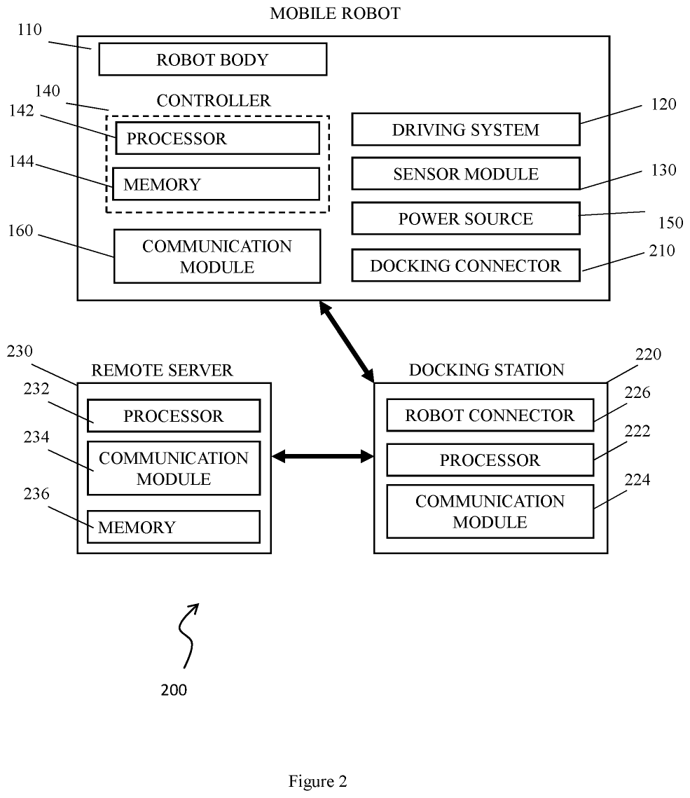

FIG. 2 discloses a schematic block diagram of a system utilizing a mobile robot, according to exemplary embodiments of the subject matter. A system 200 shown in FIG. 2 is configured for mapping the predefined area 105. The system 200 comprises the mobile robot 100, which may further comprise a docking connector 210 for connecting the mobile robot 100 to a docking station 220. The docking station 220 comprises a processor 222, a communication module 224 and at least one robot connector 226. In some embodiments, the docking station 220 may be connected to an electrical grid or to comprise a power source. In some embodiments, the docking station 220 is capable of charging rechargeable power sources. The at least one robot connector 226 of the docking station 220 is configured to connect/receive the docking connector 210 of the mobile robot 100 for charging the power source 150 thereof. The at least one robot connector 226 of the docking station 220 and the docking connector 210 may also be used to exchange information into and from the mobile robot 100. In further embodiments, the robot connector 226 may utilize wireless charging components. In such cases the robot connector 226 may utilize Qi protocol and the like for wireless power transfer and NFC, BT, Blue tooth (BLE), Wi-Fi and the like for wireless data exchange. In some embodiments, the docking station 220 may utilize the communication module 224 thereof to serve as a relay station, for example between devices in the predefined area, such as the mobile robot 100 and physical Internet of Things (IoT) devices.

In some embodiments, the docking station 220 may include at least one non-optical sensor, providing the mobile robot 100 with additional non-optical data. In further embodiments, the docking station 220 may comprise a data emitting device, serving as an anchor for the map generation. In such a case, the docking station 220 may function as a beacon.

In some embodiments, the docking station 220 may wirelessly facilitate exchange of data between the mobile robot 100 and a remote server 230. In some embodiments, the remote server 230 is configured to exchange data with the mobile robot 100 directly or through a relay station. The remote server 230 comprises a processor 232, a communication module 234 and a memory 236. In some exemplary embodiments, the remote server 230 is configured to receive data from the mobile robot 100, for example data collected by the sensor module 130, process the received data and to generate at least one map from the received data.

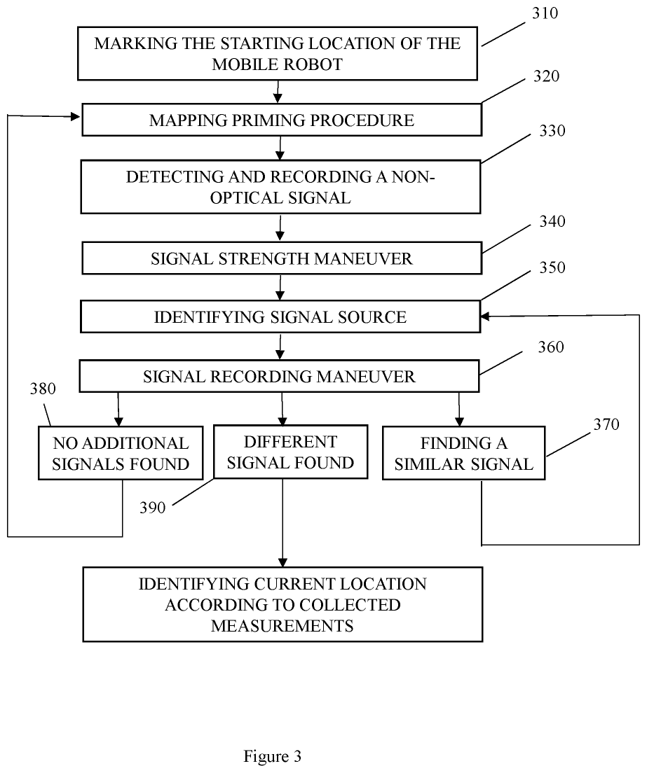

FIG. 3 discloses a method for mapping a predefined area, according to exemplary embodiments of the subject matter. In some embodiments, the mapping method is performed using the non-optical sensors of the sensor module 130. The method of mapping the predefined area may be performed by the mobile robot 100, by the remote server 230, or by both parties cooperating, for example each party performs a separate part of the mapping process. When the mobile robot 100 navigates through the predefined area, the mobile robot 100 gathers data via both sensor module 130 and the IMU 135. In some embodiments, the mobile robot 100 processes the data arriving from the IMU 135 to provide measurements for inertial tracking of the mobile robot 100. In such cases, the measurements may be used in an inertial navigation subsystem for determining the location of the mobile robot 100 and the path the mobile robot 100 advanced relative to the starting location thereof.

As disclosed in step 310, the mapping procedure of the mobile robot starts with creating a map and marking the starting location of the mobile robot 100 in the map. In some exemplary cases, the starting point of the mobile robot 100 is shown in the center of that map. In some embodiments, the map is generated as a grid comprising sub-areas designed as polygons, elliptical shapes and a combination thereof. In some embodiments, the grid comprises squares of identical or different areas or volumes, each square may be 5 cm², 10 cm², 20 cm² and the like. The map is stored in a memory unit, either in the robot device or the remote server. In some embodiments, the map stored in the memory comprises memory addresses for one or more sub-areas. For example, one memory address allocated to store data associated with a square in the grid is capable of storing values of signals measured by the sensor module 130 when the mobile robot 100 is located in the sub-area represented by the square. In such cases, when a signal is sensed by the mobile robot 100, the signal is measured and the signal strength is stored in the memory 144, associated with the square in the map's grid that the robot is on. An example for a list of measurements in the square is presented in example 1.

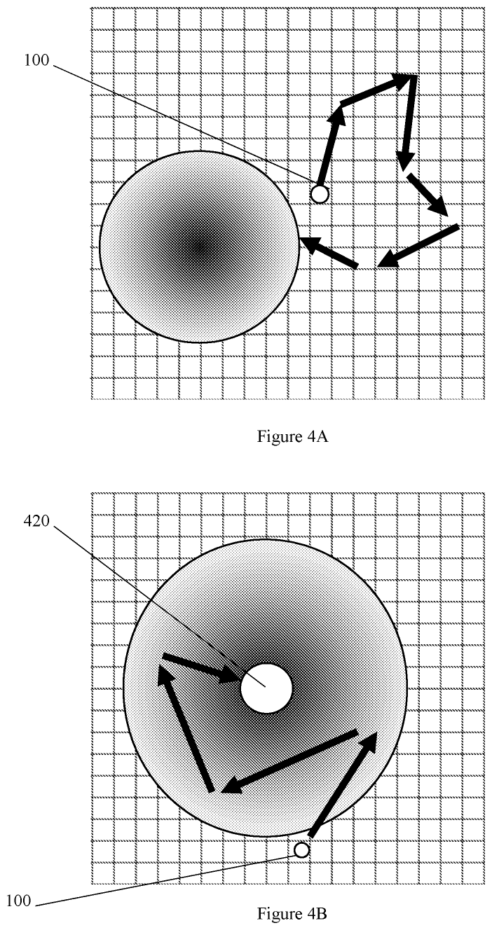

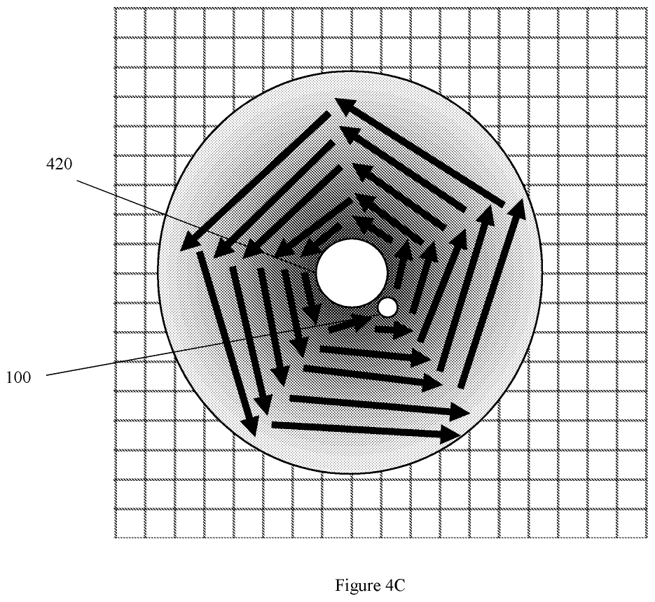

In order to start the mapping procedure, the mobile robot 100 starts a mapping priming process, as disclosed in step 320. In the mapping priming process, the mobile robot 100 senses non-optical signals using the sensor module 130. Said sensing begins in the starting location. If no signal is sensed in the starting point, the mobile robot 100 moves randomly from the starting point, aiming to sense for at least one signal. In some embodiments, the movement from the starting point is performed according to a predefined set of rules. In some other cases, the robot's movement seeking to sense a signal is performed in a random navigation direction for a short time and if no signal is sensed, the advancing direction is changed randomly until a signal is sensed. An example for such a random movement is shown in FIG. 4a.

When the mobile robot 100 navigates outwards from the sub-area associated with the starting location, the mobile robot 100 defines additional sub-areas in the map according to the path taken by the mobile robot 100. The path may be measured by the IMU 135. In such cases, the map may be generated from the starting location and outwards. In some embodiments, each generated square receives coordinates relative to the starting location.

In some embodiments, the sensor module 130 senses a first signal during the mapping priming procedure 320. When the first signal is sensed, the mobile robot 100 measures the signal strength of the signal. That signal strength and the sensor ID of the sensor that sensed the signal are stored in the memory 144, associated with the sub-area in which the signal was measured, as disclosed in step 330.

After sensing a non-optical signal, the mobile robot 100 may move according to a signal strength measurement, as disclosed in step 340. In some embodiments, the signal strength maneuver is performed by relatively short movements and measuring the signal from the same sensor in multiple locations. The manner of movement after sensing the first signal may be dictated using a predefined set of rules. The signal strength maneuver is performed in order to detect the maximal signal of the same source, and associate measurements of the same sensor with multiple sub-areas of the predefined area. For example, in case there are 1200 sub-areas, sensor #6 may provide 52 measurements for different 52 different sub-areas. The mobile robot continues the movement until identifying the source as disclosed in step 350, or until determining that the maximal possible value was measured, or until the signal weakens. The signal strength maneuver is further disclosed in FIG. 4A.

An example for a list of measurements in a sub-area is presented in example 1:

### EXAMPLE 1

Square location: 2534/1475; heat: 29.3 Celsius, Wi-Fi signal strength: saloon 130, bedroom 70, kitchen 150; humidity: 24%, wind strength and direction: etc. the sensed values may vary according to date, time in the day, number of persons in the predefined area, predefined events and the like.

Upon identifying the signal source, or the maximal sensed value of the sensor, the robot may mark the source location and continue to navigate in the predefined area, looking for additional sensed signals. The navigation ends after the mobile robot 100 determines that all the predefined area was covered. In some exemplary cases, after identifying a signal source, the robot performs a signal recording maneuver, as disclosed in step 360, in which the robot searches for additional measurements of the same source. In step 370, the mobile robot marks the map with additional signals detected by the same sensor or by additional sensors in a specific sub-area. In some embodiments, if the mobile robot 100 does not detect any signal from other non-optical sensors during the signal recording maneuver, as disclosed in step 380, the mobile robot 100 returns to the mapping priming procedure 320 to detect signals from additional sensors.

In some embodiments, a signal is detected by a second sensor during the navigation of the mobile robot to the completion of the recording maneuver for the first sensor, as disclosed in step 390. In such cases, the mobile robot 100 measures the signal strength of the second sensor and records the signal strength of the second sensor in the memory 144 for the relevant sub-area. In some embodiments, the mobile robot may continue recording the second signal in addition to the current maneuver. In some exemplary cases, after completion of the recording maneuver for the first signal source, the mobile robot 100 moves to the sub-area in which the second sensor detected a signal and starts a signal strength maneuver for the signal of the second sensor. In some exemplary cases, the mobile robot 100 generated a gradient map of all the signals sensed in the predefined area.

Step 395 discloses identifying the mobile robot's current location according to non-optical signals sensed by the sensor of the sensor module 130. For example, in case sensors #2 and #13 sense signals in a specific location, correlating the sensed measurements may be used to identify the robot's location. For example, humidity sensor senses a humidity value that matches sub-areas number 272-300 while noise sensor senses noise that matches sub-areas 120-126, 195, 280 and 322. The processing module of the mobile robot may determine that the mobile robot is located in sub-area 280. Associating measurements to sub-areas may depend on signal sensitivity and predefined rules. For example, in case prior humidity measurements of a specific sub-area were 26%, current measurement of 25.5% also qualifies as a possibility that the robot is located in the specific sub-area. In some embodiments, the sub-areas may be rated in a relative manner to prior measurements.

In some embodiments, the mobile robot may detect signals from moving objects, such as a chemical from a pet, wifi signals from a robot vacuum cleaner, radio signals from a cellphone in a person's pocket and the like. Signals deriving from moving sources may disturb the generation of the non-optical maps, which are anchor based. Therefore, the moving signal sources (anchors) are required to be identified as anchors in order to determine whether to process the signals or ignore them. The mobile robot may utilize several methods to determine whether the signal source is defined as an anchor. In some embodiments, the mobile robot will maintain its location for a predefined duration upon receiving a new signal. If the signal strength was increased or decreased during the predefined duration relative to a predefined threshold, the mobile robot 100 may deduce that the signal source is mobile and ignore that signal. Other methods for identifying moving objects may by utilize Doppler effect.

In some embodiments, during the signal strength maneuver, the mobile robot 100 samples the signal strength, and creating a partial mapping of that signal strength.

In some embodiments, the mobile robot 100 may receive a map of the area and record the signal strength on the received map. In such cases, the mobile robot 100 may skip the signal strength maneuver and proceed to record the non-optical signals while navigating using the received map.

In further embodiments, the mobile robot 100 may use ulstasonic/ToF sensors to generate a map of the area surrounding the mobile robot 100 by measuring the distance to surrounding obstacles. In such cases, the surrounding obstacles may serve as boundaries allowing navigation inbetween for the mobile robot 100 and may replace the signal strength maneuver as disclosed earlier.

In some embodiments, when there is a large no-signal sub-area, the mobile robot 100 may place a beacon (not shown) emitting a known signal for providing a known anchor to navigate around. In such cases, the data received from the beacon may be measured but not recorded/marked in the generated map.

FIGS. 4A-4C disclose navigation maneuvers performed by the mobile robot during the mapping procedure, according to exemplary embodiments of the subject matter. FIG. 4a discloses an exemplary mapping priming procedure 320, in which the robot starts a series of movements for increasing the chance to sense a signal. In some exemplary embodiments, the movement may be completely random. In further embodiments, the movement may be made in a clockwise pattern or in accordance with a predefined rule. In such cases, the mobile robot 100 may advance a short distance, and if a signal is not sensed, the mobile robot 100 travels back to the starting location and spins a few degrees clockwise until a signal is sensed. In the embodiments described in FIG. 4A, the movement is made in a similar manner to chemotaxis movements of some bacteria. In such cases, the robot moves forward for a short distance, then turn randomly to a different direction, moves in that direction for another short distance, and so on.

FIG. 4B discloses an exemplary embodiment of the signal strength maneuver 340. The signal strength maneuver 340 is performed when a signal is first sensed by a sensor of the sensor module 130. For example, the first noise signal or the first Wi-Fi signal. After first detection of the specific signal, the mobile robot seeks for a source 420 radiating that signal. In some embodiments, the signal strength maneuver 340 is performed to identify the source. In further embodiments, the signal strength maneuver 340 is performed to map the signal thoroughly and identify the source at a certain point of the maneuver. In some cases, when the mobile robot 100 seeks the source of the signal directly, the robot makes moves in a certain direction until the source weakens or until the source is found. If the signal weakens, then the robot changes moving direction and moves forward until the signal weakens and so on.

FIG. 4C discloses an exemplary embodiment of the signal recording maneuver 360. The signal recording maneuver is made when a signal source was found by the mobile robot, and the mobile robot is instructed to record the signal area in the map. In some embodiments, the mobile robot 100 travels around the source of the signal, staying in the same signal strength radius from the source and travels farther away from the source in a spiral manner.

In some embodiments, the signal strength maneuver process may be comprised in the recording maneuver process. In such cases, the recording maneuver is designed to scan for signals of the same strength (encompassing the source). After recording the signals of the same strength, the mobile robot may advance toward an area with higher signal strength and record all of the signals with the greater strength until finding the source of the signal last.

In some embodiments, the predefined area is a volume having 3 dimensions. In such cases, the map may be generated as a matrix, the squares may be generated as cubes, and the navigation may be made using a 3D model. In other cases, the mobile robot may slice the volume into two dimensional predefined areas and to map them one by one.

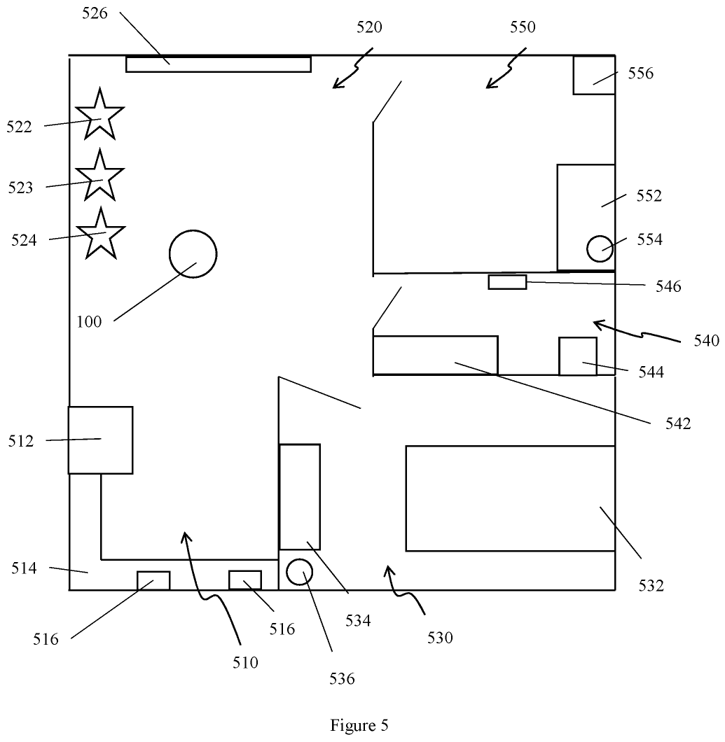

FIG. 5 discloses an exemplary predefined area with a mapping robot therein, according to exemplary embodiments of the subject matter. FIG. 5 shows the mobile robot 100 inside an exemplary predefined area 500 which is about to be mapped. The mobile robot 100 is configured to travel throughout the exemplary predefined area 500 and to generate a map thereof. In some embodiments, the exemplary predefined area 500 is a house, comprising a kitchen 510, a living room 520, a bedroom 530, a bathroom 540 and an office 550. In the exemplary predefined area 500 shown, each room comprises different characteristics (radiated signals), that the mobile robot 100 collects in order to generate a map. The kitchen 510 comprises a refrigerator 512 and a kitchen countertop 514 comprising a sink 516 and a dish rack 518. The living room 520 comprising three plants 522, 523 and 524, and a TV 526. The bedroom 530 comprises a bed 532, a closet 534 and a laundry basket 536. The bathroom 540 comprises a bath 542, a toilet 544, and a sink 546. The office 550 comprises a desk 552, a Wi-Fi router 554 placed on the desk 552, and a litter box 556.

Some objects in the exemplary predefined area 500 radiates signals. In some exemplary embodiments, the TV 526 radiates small amounts of electromagnetic waves in a certain frequency, the Wi-Fi router 554 may 2.4 GHZ and/or 5 GHZ waves and the fridge buzzes in a certain frequency. Some of the radiated signals of the objects may be detected by sensors and be processed by a processor (either the robot's processor 142, the docking station processor 222, or the remote server processor 232), into at least one value. For example, objects with high temperature may radiate infrared radiation, the air surrounding a wet surface will be more humid and the like. Additionally, many electrical devices radiate electromagnetic waves. Some of these waves may be caused by an active transmission of electromagnetic waves such that WI-FI signals, Bluetooth signals and the like. Some of the radiated radio waves are radiated passively, for example, from the electricity running through the electrical devices.

Using the sensor module 130 the mobile robot 100 travels throughout the exemplary predefined area 500, receiving the radiated signals and processing them into values. In some embodiments, the values gathered from a single location are stored in the robot memory. After generating at least two values collected by the same sensor or sensor type, the generated values may be compared in order to create a gradient. This gradient may be further processed in order to create a gradient map representing the radiated signal.

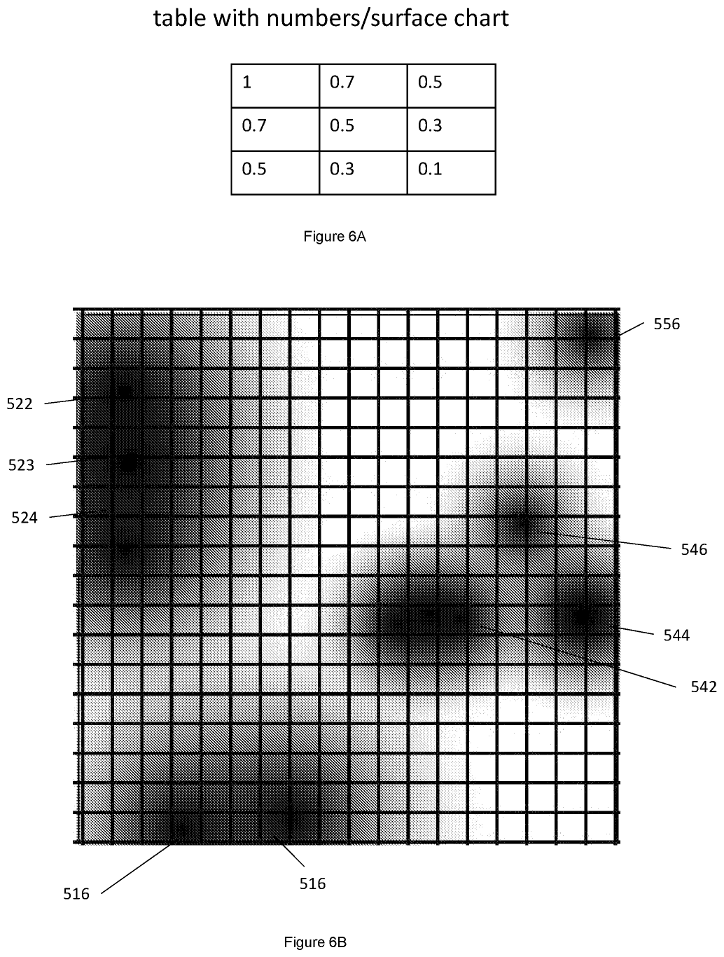

FIG. 6A-B discloses mappings of an exemplary predefined area as generated by a single sensor on a robot, according to exemplary embodiments of the subject matter. FIG. 6A shows a table of values collected by the humidity sensor of sensor module 130. While traveling in the exemplary predefined area 500, the robot collects data from the humidity sensors in the sensor module 130. The controller 140 calculates the humidity values generated and stores the values in the memory 144 thereof. As shown in FIG. 6B, in some embodiments, the controller 140 may translate the collected values into a graphical representation. The graphical representation may be presented according to the density of a pixel in a grid. As shown in the maps of FIG. 6B, some objects located inside the exemplary predefined area 500 may be surrounded by humid air. For example, the three plants 522, 523 and 524 in the living room, the sink 516 and the dish rack 518 in the kitchen, almost the entire bathroom 540 (due to the tub 542, toilet 544, and sink 546) and the cat litter box 556 in the office 550.

It should be understood that the above description is merely exemplary and that there are various embodiments of the present invention that may be devised, mutatis mutandis, and that the features described in the above-described embodiments, and those not described herein, may be used separately or in any suitable combination; and the invention can be devised in accordance with embodiments not necessarily described above.

1. A mobile robot comprising:
a robot body;
a drive system configured to maneuver the robot body in a predefined area;
a controller coupled to the drive system, said controller comprising a processor a memory; and
a sensor module in communication with the controller, wherein the sensor module comprises at least one non-optical sensor, configured to gather non-optical data from the predefined area;
a communication module configured to send signals to electronic devices in the predefined area, the signals transmitted from the communication module induce emission of signals from the electronic devices in the predefined area;
and wherein the processor is configured to generate at least one map of the predefined area using data processed from said non-optical data.

2. The mobile robot of claim 1, wherein the processor creates at least one non-optical map of the predefined area from each one of the said at least one of non-optical data.

3. The mobile robot of claim 2, wherein the processor is configured to create a map combining all of the at least one non-optical maps created by the non-optical sensor into a non-optical multilayered map.

4. The mobile robot of claim 1, wherein the non-optical data comprises signal strengths, and wherein the controller is configured to collect signal strengths from the sensor module to detect signal radiating objects.

5. The mobile robot of claim 1, wherein the controller is configured to determine the distance to said signal radiating objects based on the collected signal strength.

6. The mobile robot of claim 1, wherein the sensor module further comprises an optical sensor configured to gather optical data from said predefined area.

7. The mobile robot of claim 6, wherein the processor creates at least one non-optical map of the predefined area from the optical data.

8. The mobile robot of claim 7, wherein the controller is configured to create a map combining all of the at least one non-optical maps created and the optical map into an optical multilayered map.

9. The mobile robot of claim 8, wherein the processor creates at least one non-optical map of the predefined area from each one of the said at least one of non-optical data and an optical map from the optical data.

10. The mobile robot of claim 1, wherein the controller is configured to constantly update the at least one generated maps.

11. The mobile robot of claim 1, wherein the robot stores the generated maps and the collected data in a memory thereof.

12. The mobile robot of claim 11, wherein the controller determines the current location of said robot according to data collected from the sensors relatively to data stored in the memory.

13. The mobile robot of claim 1, wherein the at least one non-optical sensor is selected from a group including RF sensor/electromagnetic sensor, ultrasonic sensor, biological sensor/VOC sensor, sound sensor, thermal sensor, gas sensors, electro-mechanical sensors and a combination thereof.

14. The mobile robot of claim 1, wherein the at least one non-optical sensor is a discrete sensor.

15. the mobile robot of claim 1, wherein the sensor module further comprises an inertial sensor.

16. The mobile robot of claim 15, wherein the inertial sensor may be comprised of at least one of: 3-axis accelerometer, 3-axis gyroscope, magnetometer and barometer.

17. The mobile robot of claim 1, further comprising an active navigation module, wherein said active navigation module is configured to communicate with signal emitting objects.

18. The mobile robot of claim 17, wherein the active navigation module further comprises a signal emitting beacon, which can be placed in a predefined area.

19. A system for generating a map of a predetermined area comprising:
a mobile robot comprising:
a robot body;
a drive system configured to maneuver the robot body in a predefined area;
a controller coupled to the drive system, said controller comprising a processor a memory; and
a sensor module in communication with the controller, wherein the sensor module comprises at least one non-optical sensor, configured to gather non-optical data from the predefined area; and
a communication module configured to exchange data with a server or a relay station;
a docking station configured to serve as a relay station for the robot for exchanging data with a remote server, comprising a processor and a communication module; and
a server configured to receive and process data; comprising a processor, a communication module and a memory, wherein said remote server is configured to store the collected data, determine the robot's location and transmit the location to the robot and wherein the server generates a map of the predefined area based on the received data.
